(19) United States
(12) Patent Application Publication
(10) Pub. No.: US 2002/0184086 A1
(43) Pub. Date: Dec. 5, 2002

(54) Method and system for distributing targeted advertising

(76) Inventor: Leif Linde, Richardson, TX (US)

Correspondence Address: Daniel J. Chalker, GARDERE WYNNE SEWELL LLP, 3000 Thanksgiving Tower, 1601 Elm Street, Dallas, TX, 75201, US

(21) Appl. No.: 09/838,489

(22) Filed: Apr. 19, 2001

(51) Int. Cl. G06F 17/60

(52) U.S. Cl. 705/14

(57) ABSTRACT

The present invention provides an Internet based service that enables retailers to create and distribute promotions to customers based on profile criteria. These promotions are distributed to all types of wireless and mobile devices, as well as the Internet. This service also has the ability to track the reception and acceptance of the promotion from the end user, and provide the retailers with the ability to monitor the promotion activity to determine if is has been received and executed. The present invention also provides a method, computer program and system for distributing a promotion by selecting one or more subscribers to receive the promotion based on target subscriber information associated with the promotion and subscriber information associated with each subscriber, obtaining subscriber delivery information for each of the selected subscribers, and distributing the promotion to each of the selected subscribers based on the subscriber delivery information for the selected subscriber.

### FIELD OF THE INVENTION

The present invention relates generally to the field of communications systems and, in particular, to a method and system for distributing targeted advertising.

### BACKGROUND OF THE INVENTION

In advertising, it is considered highly desirable to target advertisements or promotions to the appropriate potential customer base, rather than to broadcast advertisements in general. It has long been known that, for example, advertisements for computers should generally not appear in magazines on gardening and, conversely, advertisements for gardening tools should not appear in magazines on computers. Similarly, advertisers have generally targeted their advertisements on television to programs whose viewers comprise the desired customer base.

The recent development of on-line networks, such as America On-Line, Compuserve, and the Internet, has led to “on-line” advertising. For example, on the Internet, often such on-line advertisements will appear on a web page, such as a banner on the top or the bottom of the page. When the user views a web page using a browser such as Internet Explorer 3 or Netscape 3, the banner appears at the appropriate location and the user may then try to find out more information regarding the advertisement by selecting the advertisement (clicking through on that banner) through the use of the mouse or other pointing device. This will cause an HTTP message to be generated by the browser using the information encapsulated in association with the banner to send a request for an object with a given URL address to a different appropriate web site to access, for example, the advertiser's home page.

Such advertising has had, so far, a poor rate of response because it is untargeted. Thus, someone who is totally uninterested in computers, other than they happen to be on the Internet, may continually see advertisements for computers. On the other hand, someone who is interested in computers may continually see advertisements for gardening tools when browsing through a particular web site. This type of unfocused distribution annoys consumers and leads to a decrease in the effectiveness of advertisements. Thus it would be highly desirable to have a method and system for targeting the advertisements or promotions to the appropriate user. In addition, if a consumer is continuously exposed to the same advertisement, the response rate to the advertisement will generally decline. Therefore, it is highly desirable to have a system that controls the frequency of exposure of advertisements to particular users.

The increasing mobility of society has resulted in the proliferation of mobile communication devices; advertising has thus far restricted its distribution channels to stationary media such as personal computers. Consumers need to be able to tell advertisers not only what they want, but when they want it and how they want it. Most consumers have a preferred method of communication and would be more receptive to advertising sent to them using their choices. It would be advantageous to have a method for consumers to not only select the type of advertising they receive, but also when that advertising should be delivered and through what media.

Finally, it is important for the advertisers to track responses to the advertisements and to acquire as much information about those people responding to the advertisements for targeting those same people at later dates. Many retailers have been using general demographics and conventional media without any ability to immediately monitor the success of the promotion. Rather than enlisting marketing firms to perform surveys or conduct focus groups, retailers need to be able to immediately validate the direct success of a promotion and determine the revenue generated by a promotion in order to determine whether or not to continue a promotion.

Accordingly, there is a need for a method and system for providing targeted advertising not only over networks such as the Internet, but also through wireless communications such as pagers and cell phones. There is also a need for a method and system for providing targeted advertising that minimizes consumer exposure to redundant advertisements and keeps the consumer's sensitive information private. Additionally, there is a need for a method and system that enables consumers to select preferred advertisement types, delivery times and delivery methods. There is also a need for a method and system that provides immediate retailer feedback regarding the effectiveness of the targeted advertising.

### SUMMARY OF THE INVENTION

The present invention provides a method and system for distributing targeted advertising. The present invention is a network-based service that enables advertisers, merchants or content providers to create and distribute targeted advertisements or promotions through various networks, such as the Internet and wireless networks, to various receiving devices, such as computers, telephones, cell phones, fax machines, pagers and personal data assistants (“PDA”). The present invention minimizes the consumer's exposure to redundant advertising and allows them to select the type of advertising they receive, when they receive it and how they receive it.

The present invention also enables the advertisers to receive feedback regarding the effectiveness of the targeted advertising, such as response to the advertisement and revenue generated by the advertisement. As a result, the advertiser can continuously alter the advertisement to get the best results. The advertiser can also simulate a distribution of the advertisement to determine whether to post the advertisement as is or make modifications. The advertisement can be programmed to cease after a certain number of customers have been reached. As used herein, the terms promotion and advertisement are used interchangeably. Moreover, the terms customer, consumer and subscriber are used interchangeably. Similarly, the terms advertiser, merchant, seller and content provider are used interchangeably.

More specifically, the present invention provides a method for distributing a promotion by selecting one or more subscribers to receive the promotion based on target subscriber information associated with the promotion and subscriber information associated with each subscriber, obtaining subscriber delivery information for each of the selected subscribers, and distributing the promotion to each of the selected subscribers based on the subscriber delivery information for the selected subscriber. The present invention also includes a computer program embodied on a computer readable medium for distributing a promotion that includes codes segments for performing the steps described above.

The present invention also provides a method for distributing a promotion by receiving a request to distribute the promotion, retrieving the promotion and target subscriber information associated with the promotion from a first database, retrieving subscriber information for one or more subscribers from a second database, selecting the subscriber when a comparison of target subscriber information to the subscriber information for the subscriber satisfies one or more rules, requesting subscriber delivery information for each selected subscriber using a subscriber identification for each selected subscriber, wherein the subscriber delivery information is stored on a third database, receiving the subscriber delivery information, creating a message that contains the promotion and is formatted for a receiving device for each selected subscriber, and sending the message to the receiving device for each selected subscriber if the selected subscriber has not been sent a specified number of messages within a specified time period. The present invention also includes a computer program embodied on a computer readable medium for distributing a promotion that includes codes segments for performing the steps described above.

In addition, the present invention provides a system for distributing a promotion that includes a profile manager, a subscriber selector, a first database, a second database, a third database and a distributor. The subscriber selector is communicably connected to the profile manager. The subscriber selector selects one or more subscribers to receive the promotion based on target subscriber information associated with the promotion and subscriber information associated with each subscriber, and obtains subscriber delivery information for each of the selected subscribers via the profile manager. The first database is communicably connected to the subscriber selector and stores the target subscriber information. The second database is communicably connected to the subscriber selector and stores the subscriber information. The third database is communicably connected to the profile manager and stores the subscriber delivery information. The distributor is communicably connected to the subscriber selector and distributes the promotion to each of the selected subscribers based on the subscriber delivery information for the selected subscriber.

The present invention also provides a system for distributing a promotion that includes a first database, a second database, a third database, a profile manager, a subscriber selector and a distributor. The first database stores target subscriber information for the promotion. The second database stores subscriber information for one or more subscribers. The third database stores subscriber delivery information for the one or more subscribers. The profile manager is communicably connected to the third database and retrieves subscriber delivery information from the third database. The subscriber selector is communicably connected to the profile manager, the first database and the second database. The subscriber selector retrieves the promotion and target subscriber information associated with the promotion from the first database, retrieves subscriber information for the one or more subscribers from the second database, selects the subscriber when a comparison of the target subscriber information to the subscriber information for the subscriber satisfies one or more rules, obtains subscriber delivery information for each of the selected subscribers using a subscriber identification for each selected subscriber via the profile manager, and creates a message that contains the promotion and is formatted for a receiving device for each selected subscriber. The distributor is communicably connected to the subscriber selector. The distributor sends the message to the receiving device for each selected subscriber if the selected subscriber has not been sent a specified number of messages within a specified time period.

### BRIEF DESCRIPTION OF THE DRAWINGS

The above and further advantages of the present invention may be understood by referring to the following description in conjunction with the accompanying drawings in which corresponding numerals in the different figures refer to the corresponding parts in which:

FIG. 1 depicts a block diagram of an overall system in accordance with the present invention;

FIG. 2 depicts a representative list of subscriber categories in accordance with one embodiment of the present invention;

FIG. 3 depicts a representative list of subscriber demographics in accordance with one embodiment of the present invention;

FIG. 4 depicts a representative chart displaying subscriber interest levels in accordance with one embodiment of the present invention;

FIG. 5 depicts a sequence diagram of creation of a subscriber profile in accordance with the present invention;

FIG. 6 depicts a sequence diagram of creation and maintenance of a promotion in accordance with the present invention;

FIG. 7 depicts a sequence diagram of promotional results simulation in accordance with the present invention; and

FIG. 8 depicts a sequence diagram of operation of a system in accordance with the present invention.

### DETAILED DESCRIPTION OF THE INVENTION

While the making and using of various embodiments of the present invention are discussed herein in terms of a targeted advertising distribution method, system and apparatus, it should be appreciated that the present invention provides many applicable inventive concepts that can be embodied in a wide variety of specific contexts. The specific embodiments discussed herein are merely illustrative of specific ways to make and use the invention and are not meant to limit its scope in any way.

The present invention provides a method and system for distributing targeted advertising. The present invention is a network-based service that enables advertisers, merchants or content providers to create and distribute targeted advertisements or promotions through various networks, such as the Internet and wireless networks, to various receiving devices, such as computers, telephones, cell phones, fax machines, pagers and personal data assistants (PDAs). The present invention minimizes the consumer's exposure to redundant advertising and allows them to select the type of advertising they receive, when they receive it and how they receive it.

The present invention also enables the advertisers to receive feedback regarding the effectiveness of the targeted advertising, such as response to the advertisement and revenue generated by the advertisement. As a result, the advertiser can continuously alter the advertisement to get the best results. The advertiser can also simulate a distribution of the advertisement to determine whether to post the advertisement as is or make modifications. The advertisement can be programmed to cease after a certain number of customers have been reached. As used herein, the terms promotion and advertisement are used interchangeably. Moreover, the terms customer, consumer and subscriber are used interchangeably. Similarly, the terms advertiser, merchant, seller and content provider are used interchangeably.

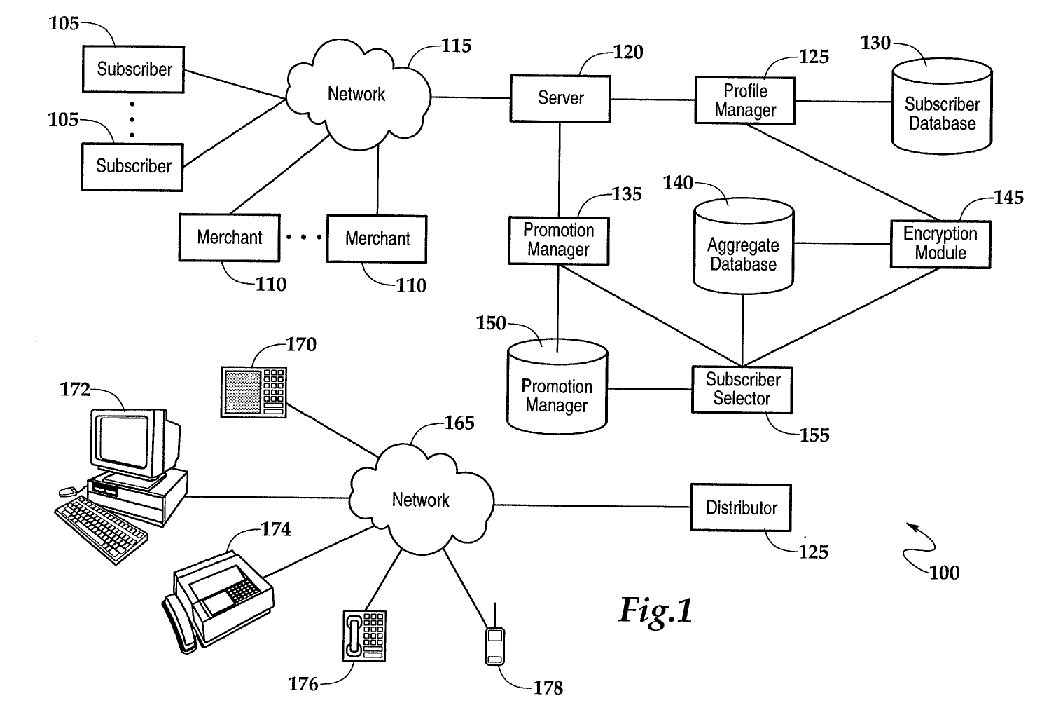

FIG. 1 depicts a block diagram of an overall promotion system 100 in accordance with a preferred embodiment of the present invention. Subscribers 105 and Merchants 110 interact with the promotion system through Network 115. Although the present invention is described as a service to which individuals, customers or consumers subscribe; the service may be free of charge to the subscriber or be included as part of other services provided to the subscriber. Accordingly, a subscriber can be anyone who submits a subscriber profile, either directly or indirectly, to the service. The Network 115 can be any type of network or combination of networks, such as the Internet, telephone, wireless or satellite networks.

The present invention includes a Server 120, a Profile Manager 125, a Subscriber Database 130 (also referred to as the third database), a Promotion Manager 135, an Aggregate Database 140 (also referred to as the second database), an encryption module 145, such as Cryptit, a Promotion Database 150 (also referred to as the first database), a Subscriber Selector 155 and a Distributor 160. Server 120, Profile Manager 125, Subscriber Database 130, Promotion Manager 135, Aggregate Database 140, encryption module 145, Promotion Database 150, Subscriber Selector 155 and Distributor 160 can be resident on a signal computer or distributed over several computers via a local or wide area network. Moreover, the functions provided by Server 120, Profile Manager 125, Promotion Manager 135, encryption module 145, Subscriber Selector 155 and Distributor 160 can be performed by a single computer program or by multiple computer programs.

Server 120 provides one or more interfaces that allow the Subscribers 105 and Merchants 110 to use the service. In the case of the Internet, the Server 120 contains the web pages and applets that enable the interaction with the Subscribers 105 and Merchants 110. The Server 120 also contains the applications that run the system. These applications are typically written in such languages as APS, Java 2E and EJB (Enterprise JavaBeans). LDAP (Lightweight Directory Access Protocol) is a set of protocols for accessing information directories used to perform authentication and access certain types of subscriber data. LDAP supports TCP/IP, which is necessary for Internet access. LDAP should eventually make it possible for almost any application running on virtually any computer platform to obtain directory information, such as e-mail addresses. Because LDAP is an open protocol, application developers need not worry about the type of server hosting the directory. The Server 120 will also include interfaces to allow telephones, cell phones and PDA's to access the system.

Likewise, Distributor 160 provides one or more interfaces that allow promotions or messages to be sent to the PDAs 170, Computers 172, Fax machines 174, Telephones 176, Mobile Phones 178 and other receiving devices of the Subscribers 105 via Network 165. Network 165 can be any type of network or combination of networks, such as the Internet, telephone, wireless or satellite networks. Network 165 may also be the same as Network 115.

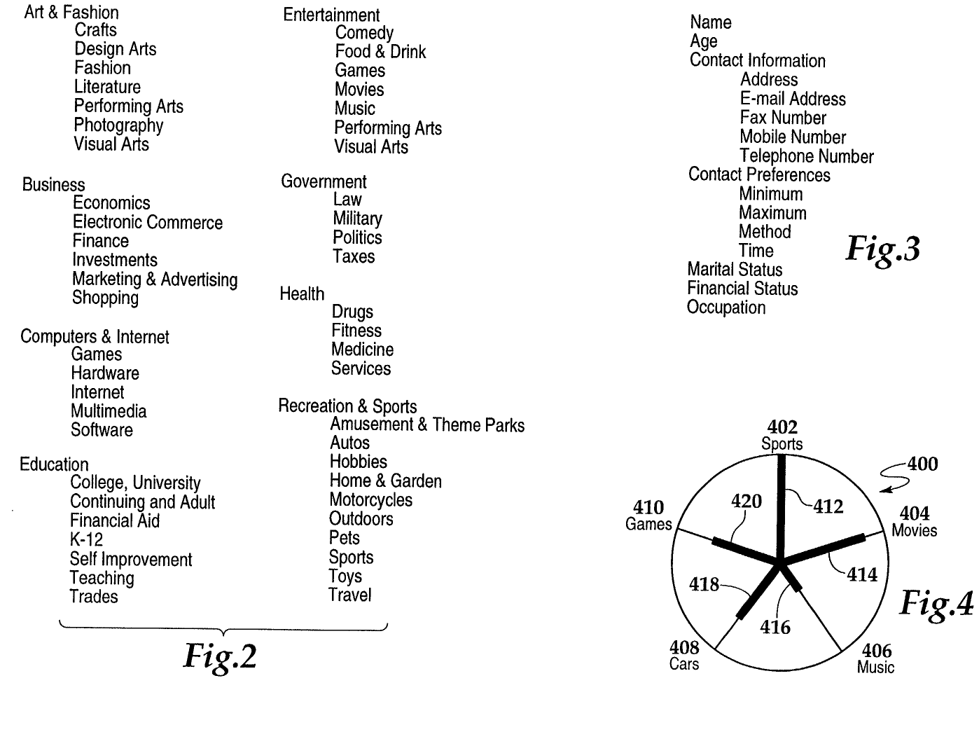

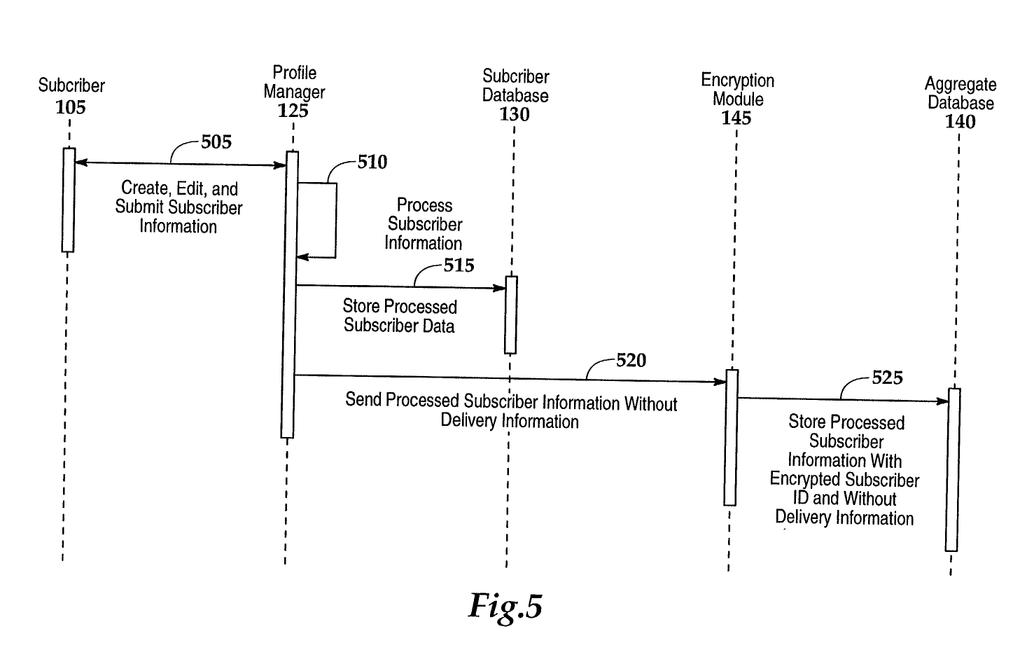

Subscribers 105 create, edit and submit subscriber profiles using a graphical user interface (GUI) applet, such as a “Lambert Tool”. This process is described more specifically in reference to FIG. 5. The subscriber profiles are processed by Profile Manager 125 and stored in Subscriber Database 130. The subscriber profiles are described in more detail in reference to FIGS. 2, 3 and 4. Access to the Subscriber Database 130 is limited and controlled by the Profile Manager 125 to protect sensitive subscriber information from disclosure to third parties. Accordingly, the Profile Manager 125 processes each new subscriber profile by creating a unique subscriber identification and associating the subscriber identification with the subscriber profile. The subscriber identification is thereafter used to access the subscriber profile in the Subscriber Database 130. The Profile Manager 125 also processes each subscriber profile by encrypting the subscriber identification using the encryption module 145 and storing the non-sensitive subscriber information from the subscriber profile along with the encrypted subscriber identification in the Aggregate Database 140. The non-sensitive subscriber information in the Aggregate Database 140 can then be used by the system, advertisers or third parties without compromising the private or sensitive subscriber information of Subscribers 105.

The Aggregate Database 140 can be used to fine tune promotions to reach the best audience, simulate a distribution of the promotion or gather other marketing information. By using a separate Subscriber Database 130 and Aggregated Database 140, the present invention satisfies the desires of most Subscribers to have their sensitive subscriber information kept private and secure. This added security should increase the number of Subscribers 105 and increase the amount and accuracy of the subscriber information.

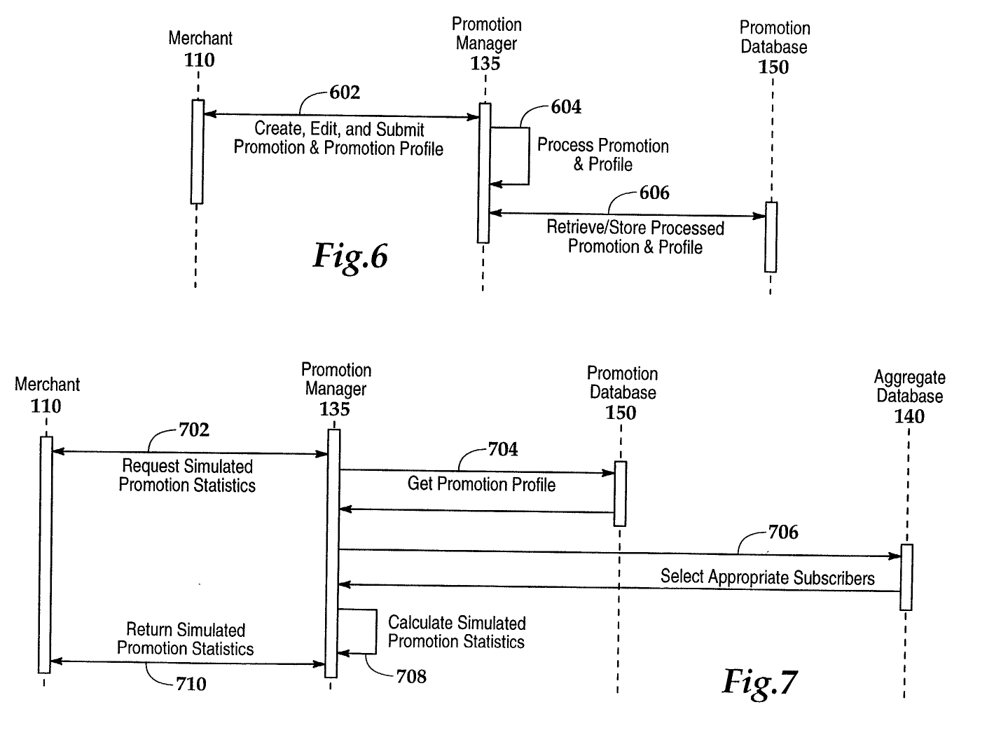

Merchants 110 create, edit and request distribution of promotions using the Promotion Manager 135 via Network 115 and Server 120. This process is described more specifically in reference to FIG. 6. Each promotion is stored along with a promotion profile in Promotion Database 150. The promotion may be as simple as a text message or as complex as a multimedia presentation. The promotion profile may specify a target audience, delivery parameters and response parameters. In order to select a target audience for the promotion, the Merchant 110 will use the Promotion Manager 135 to select target subscriber information, which may include certain subscriber preference categories, minimum and maximum values for those subscriber preference categories and non-sensitive demographic information. Subscriber preference categories and non-sensitive demographic information are described in more detail in reference to FIGS. 2 and 3. The delivery parameters may limit the receiving devices to which the promotion may be sent or limit the time period in which the promotion may be sent or limit the number of subscribers 105 that will receive the promotion. The response parameters may allow the subscriber to respond directly to the promotion or specify the type of feedback desired after the promotion is distributed.

After the Merchant 110 creates the promotion and promotion profile, the Merchant 110 can simulate a distribution of the promotion using the Promotion Manager 135. This process is described more specifically in reference to FIG. 7. This allows the Merchant 110 to test the promotion and adjust the target subscriber information to increase the successfulness of the promotion before it is distributed. The Merchant 110 can also use the Promotion Manager 135 to access and analyze the information stored in the Aggregate Database 140. The Promotion Manager 135 interfaces with Subscriber Selector 155, Promotion Database 150 and Aggregate Database 140 using LDAP. A correlation may be made between the data in Aggregate Database 140 and the data in Promotion Database 150.

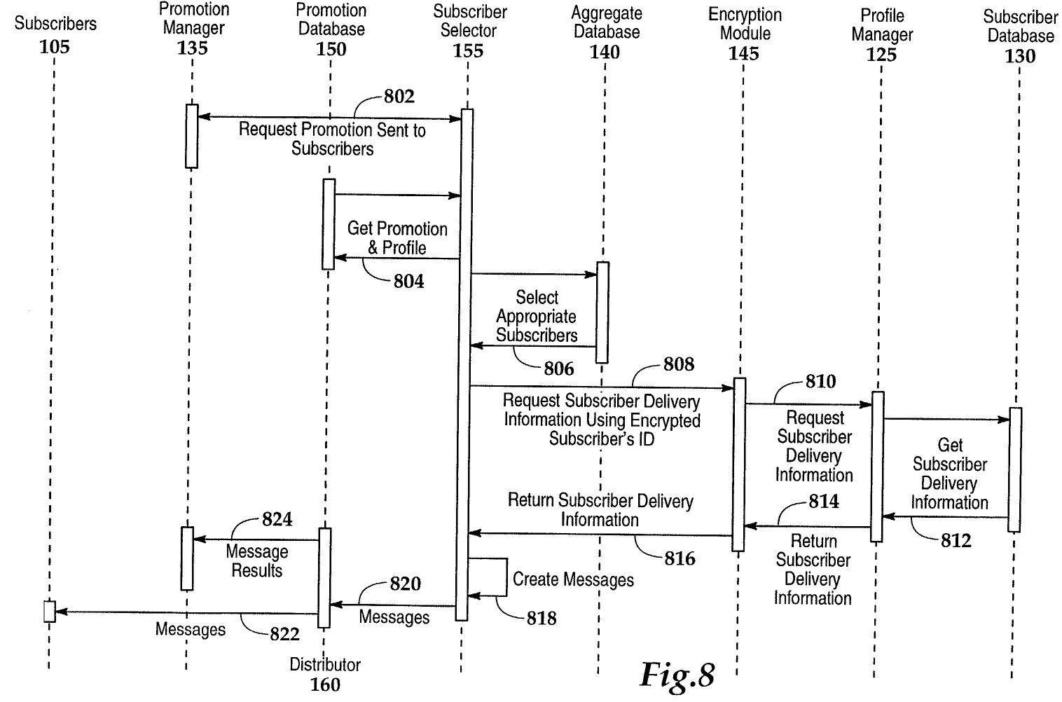

The Merchant 110 may also request that the promotion be distributed using the Promotion Manager 135. This process is described more specifically in reference to FIG. 8. In order to distribute a promotion, Promotion Manager 135 invokes Subscriber Selector 155, which selects one or more subscribers to receive the promotion from the Aggregate Database 140. Subscriber Selector 155 then uses encryption module 145 to decrypt the encrypted subscriber identification obtained from Aggregate Database 140 for the selected subscribers. The decrypted subscriber identification for each selected subscriber is sent to the Profile Manager 125, which uses the decrypted subscriber identification to access subscriber delivery information in Subscriber Database 130. The subscriber delivery information is relayed back to Subscriber Selector 155. Subscriber Selector 155 then creates a properly formatted message for the selected subscribers using the promotion and the subscriber's delivery information. The messages are then sent to Distributor 160 for distribution to the selected subscribers at the appropriate time via Network 165.

Based on the subscriber delivery information, Distributor 160 determines the type of transmission protocol to use. For example, Subscriber Selector 155 could relay a pager or mobile phone number to Distributor 160. Distributor 160 would then utilize SNPP (Simple Network Paging Protocol) to send promotional information via the specific pager or mobile phone 178 number. Subscriber Selector 155 could relay an e-mail address to Distributor 160. Distributor 160 would then use SMTP (Simple Mail Transfer Protocol) to send promotional information via e-mail. Both SNPP and SMTP are protocols for sending messages over the Internet. If Distributor 160 has sent promotional information through Network 165 via SMTP, the e-mail may be accessed through an e-mail application running on PDA 170, Computer 172 or Mobile 178. If Distributor 160 has sent promotional information through Network 165 via SNPP, the promotional information will be accessible with Mobile 178. Alternatively, Subscriber Selector 155 could send a telephone or fax number to Distributor 160. The promotional information would then be delivered via Telephone 176 or Fax 174.

The subscriber profiles created by Subscribers 105 contain data elements such as interests and demographic information. Subscribers 105 may select entire categories, such as Business or Education, or individual subcategories, such as Business:Economics or Entertainment:Music. Subscribers 105 may also indicate strength of interest in a category or subcategory.

Now referring to FIG. 2, a representative list of subscriber categories in accordance with one embodiment of the present invention is shown. Subscriber categories and target subscriber categories may include Art & Fashion, Business, Computers & Internet, Education, Entertainment, Government, Health, and Recreation & Sports. The subcategories for Art & Fashion may include Crafts, Design Arts, Fashion, Literature, Performing Arts, Photography and Visual Arts. The subcategories for Business may include Economics, Electronic Commerce, Finance, Investments, Marketing & Advertising and Shopping. The subcategories for Computers & Internet may include Games, Hardware, Internet, Multimedia and Software. The subcategories for Education may include College/University, Continuing and Adult, Financial Aid, K-12, Self Improvement, Teaching and Trades. The subcategories for Entertainment may include Comedy, Food & Drink, Games, Movies, Music and Performing Arts. The subcategories for Government may include Law, Military, Politics and Taxes. The subcategories for Health may include Drugs, Fitness, Medicine and Services. The subcategories for Recreation & Sports may include Amusement & Theme Parks, Autos, Hobbies, Home & Garden, Motorcycles, Outdoors, Pets, Sports, Toys and Travel. Other categories and subcategories may be used. In addition to subscriber categories, the subscriber profile also includes demographic information about the Subscriber 105.

Referring now to FIG. 3, a representative list of subscriber demographics in accordance with one embodiment of the present invention is shown. In addition to standard demographic information like name and age, Subscribers 105, 205 also enter their preferred mode for receiving promotional information. Subscribers 105 may enter subscriber delivery information in the form of mailing addresses, e-mail addresses, fax numbers, mobile numbers and/or telephone numbers. Subscribers 105 also indicate their contact preference. For example, subscriber 105 may prefer to receive no less than three (3) promotions per day and no more than eight (8) promotions per day. Therefore, Subscriber 105 would enter a “3” for “Minimum” and an “8” for “Maximum.” Further, Subscriber 105 may prefer to receive promotional information via e-mail. In that case, Subscriber 105 would indicate “e-mail” for the “Method.” Subscriber 105 would also indicate the order in which they preferred to receive promotional information. For example, Subscriber 105 may prefer to receive promotional information via e-mail. If the e-mail is unsuccessful, the Subscriber 105 may designate delivery via fax as a first alternative delivery method and finally regular mail as a second alternate delivery method. This information would be indicated in the subscriber's profile.

The Subscriber 105 may also specify different delivery priorities for different time period. For example, the Subscriber 105 may select e-mail delivery between 9:00 am and 5:00 pm and PDA or wireless delivery between 7:00 pm and 10:00 pm. Additionally, Subscriber 105 may prefer to receive promotional information a variety of ways. Subscribers 105 may also be able to indicate which categories of promotional information they want sent through which specific methods and minimum and maximum amounts per contact method. Subscribers 105 may also disable contact methods. All this information, including the receiving device type and the receiving device address are included in the subscriber delivery information.

Subscriber demographic information may include sensitive demographic information, non-sensitive demographic information and subscriber delivery information. The sensitive demographic information for the Subscribers 105 may include name, social security number, driver's license number, credit card numbers, bank account numbers and contact information. The non-sensitive information for the Subscribers 105 may include age, contact preferences, marital status, financial status and occupation. The demographic information will be defaulted as either sensitive or non-sensitive. The Subscribers 105 may change the defaults to designate any particular part of the demographic information as sensitive or non-sensitive. The demographic information designated as sensitive will not be disclosed to third parties. The delivery information for the Subscribers 105 may include contact information and contact preferences. The contact information may include Address, E-mail Address, Fax Number, Mobile Number and Telephone Number. The contact preferences may include Contact Preferences, Minimum number of promotions within a time period, Maximum number of promotions within a time period, the Method in which the promotions may be sent and the Time in which the promotions may be sent.

Now referring to FIG. 4, a representative graphic 400 displaying subscriber interest levels in accordance with one embodiment of the present invention is shown. The graphic 400 is displayed as part of the Profile Manager 125 and provides the Subscriber 105 with a visual indication of his or her selected preference categories and level of interest. The graphic 400 may display one or more interest categories or sub-categories, such as Sports 402, Movies 404, Music 406, Cars 408 and Games 410, in a circular arrangement. An interest level, if provided by the Subscriber 105, will be displayed as a thicker, darkened or colored bar extending from the center towards the perimeter of the circle. The length of the thicker, darkened or colored bar indicates the strength of the Subscriber's 105 interest in each category. For example, the thicker, darkened or colored bar would not be present if the category or sub-category had an interest value of zero, but the thicker, darkened or colored bar would extend to the perimeter of the circle if the category or sub-category had an interest value of five. Any range of interest values can be used, such as one to five or one to ten. The interest values could be assigned to entries such as Not Interested, Mildly Interested, Interested, Strongly Interested or Extremely Interested. For example, the graphic 400 indicates the Subscriber 105 is Extremely Interested 412 in Sports 402, Strongly Interested 414 in Movies 404, Mildly Interested 416 in Music 406, Interested 418 in Cars 408 and Interested 420 in Games 410. These interest values can be adjusted by clicking on the interest bar and dragging it to the desired level. This same type of graphic can be used by the Promotion Manager 135 to provide individual or aggregate subscriber information to Merchants 110 during the creation, editing, simulation and distribution of promotions and their associated promotion profiles.

FIG. 5 depicts a sequence diagram of creating, editing and submitting a subscriber profile in accordance with the present invention. Subscriber 105 creates, edits and submits subscriber information 505 to the Profile Manager 125. Profile Manager 125 processes the subscriber information 510 and stores the processed subscriber data 515 in Subscriber Database 130. Profile Manager 125 also sends processed subscriber information without delivery information 520 through encryption module 145 for encryption of the subscriber identification prior to storing the processed subscriber information with encrypted subscriber identification and without delivery information 525 in Aggregate Database 140. Subscriber Database 130 is a secure, object-oriented database. Aggregate Database 140 is a relational database that contains non-secure information of a mundane, non-sensitive nature relating to subscriber preferences, strengths of interest, times a promotion can be received, and so forth.

FIG. 6 depicts a sequence diagram of creation and maintenance of a promotion in accordance with the present invention. Merchant 110 creates, edits and submits promotions and promotion profiles 602 through Promotion Manager 135. Promotion Manager 135 processes the promotions and profiles 604. Promotion Manager 135 stores processed promotions and profiles 606 in Promotion Database 150. When Merchant 110 accesses the stored promotion and profiles, Promotion Manager 135 retrieves processed promotions and profiles 606 from Promotion Database 150. Promotion Database 150 may be an Oracle database.

FIG. 7 depicts a sequence diagram of promotional results simulation in accordance with the present invention. In order to obtain immediate feedback regarding the effectiveness of a proposed targeted promotion, Merchant 110 can run a simulated promotional campaign. Merchant 110 requests simulated promotion statistics 702 from Promotion Manager 135. Promotion Manager 135 gets the promotion profile 704 from Promotion Database 150. Promotion Manager 135 then selects appropriate subscribers 706 from Aggregate Database 140. Appropriate subscribers are those whose interests match a particular promotion profile. Promotion Manager 135 calculates simulated promotion statistics 708. Such statistics can include the total number of promotions sent, the number of promotions sent during specific time periods, the number of promotions sent to specific contact methods and the number of promotions sent to males vs. females. Promotion Manager 135 returns the simulated promotion statistics 710 to Merchant 110. The statistics may be displayed in report, spreadsheet, database and/or graphic form.

Merchant 110 can use the simulated promotion statistics to determine whether to distribute the promotion as it is or modify the promotion profile 704 to improve the expected results. The simulation can then be re-run using the new promotion profile. This process can be repeated until the expected results are satisfactory to the Merchant 110. As a result, the Merchant is able to maximize the results and potential payback (revenue) for a given promotion.

FIG. 8 depicts a sequence diagram of operation of a system in accordance with the present invention. Promotion Manager 135 contacts Subscriber Selector 155 and requests that a promotion be sent to subscribers 802. Subscriber Selector 155 gets the promotion and profile 804 from Promotion Database 150. Subscriber Selector 155 then selects appropriate subscribers 806 from Aggregate Database 140. Appropriate subscribers are those who can receive promotions at a given point in time and whose interests match the profile. Subscriber Selector 155 also obtains the encrypted subscriber identification from Aggregate Database 140. Subscriber Selector 155 then requests subscriber delivery information 808 through Encryption Module 145. Encryption Module 145 decrypts the encrypted subscriber identification in order to request subscriber delivery information 810 through Profile Manager 125. Alternatively, Subscriber Selector 155 could request subscriber delivery information from Profile Manager 125, supplying Profile Manager 125 with the encrypted subscriber identification. Profile Manager 125 would then contact Encryption Module 145 for decryption of the encrypted subscriber identification.

Profile Manager 125 retrieves the subscriber delivery information 812 from Subscriber Database 130 and returns the subscriber delivery information 814 through Encryption Module 145, which passes the subscriber delivery information 816 to Subscriber Selector 155. Subscriber Selector 155 creates messages 818. These messages comprise promotional information and delivery information. Messages 820 are sent to Distributor 160. Message Results 824 are sent from Distributor 160 to Promotion Manager 824. Message Results 824 may comprise error messages, delivery descriptors, promotional statistics and revenues derived from the promotion. Messages 822 are delivered to Subscribers 805 as selected by Subscriber Selector 155 from Aggregate Database 140. A future Subscriber Selector 155 will be completely subscriber-centric.

A subscriber only receives one copy of a promotion. Once a promotion has been sent, a flag is marked for that subscriber for that promotion to prevent that promotion from being re-sent to that subscriber. The present invention distributes promotions that are a best fit to the subscriber. This determination will be performed using “Best Fit” rules, such as: 1) Time Window Fit (i.e., the promotion is distributed to the subscriber only in the time window specified by the subscriber; 2) The subscriber shall not receive the promotion twice. This is to ensure that the subscriber does not get spammed by the same promotion. Although a subscriber may have the ability to receive promotions on multiple devices, a subscriber should not receive the same promotion on multiple devices; 3) Subscriber preferences match the promotion preferences specified by the advertiser; and 4) The subscriber sets the best X matching promotions (i.e., X is set by the subscriber). The promotion quintile and the subscriber quintile must match.

In order to ensure that the promotion quintile and the subscriber quintile match, a ranking system should be established. The subscriber preferences are in a range of 0-100. The subscriber selects an interest level for each preference using the GUI applet “Lambert Tool.” The advertiser has selected a preference profile for each promotion. Each preference is selected in quintiles, leading to a range of five (5) quintiles for each preference. The preference profile can consist of multiple preferences. Each eligible subscriber's preferences are compared to each promotion preference profile for active promotions. This comparison leads to a resulting weight. The formula for the weight is: Σ(Subscriber Preference×Promotion Preference×Quintile from Promotion) for all promotion preferences.

For example, assume that the stored subscriber preferences are: skiing 70%, football 90% and Italian Food 100%. Also assume that the stored promotion preference profile is: skiing>60% and Italian Food>80%. The weight would then be: (0.7*0.6*4)+(1.0*0.8*5)=1.68+4.0=5.68. For each promotion, a list of subscriberPK and weight tuple is stored and sorted by weight. The following table might result from such calculations:

| | | | |
|---|---|---|---|
| Promo1 | Joe 4.5 | Mary 4.4 | Scott 3.9 |
| Promo2 | Mary 5.5 | Joe 3.1 | Scott 2.1 |
| Promo3 | Joe 7.0 | Greg 5.5 | |

If Joe were to receive only one promotion, he would receive Promo3. If Mary were to receive only one promotion, she would receive Promo2. If there is a tie wherein two (2) promotions have the same weighting, the following rules can be applied: 1) Choose the promotion that is going to end its distribution first; 2) Choose the merchant who has the least number of active promotions in the system; 3) Choose the promotion that has the earliest published time stamp. However, these tiebreaker rules will not be fully effective until the Subscriber Selector is subscriber-centric.

While specific alternatives to steps of the present invention have been described herein, additional alternatives not specifically disclosed but known in the art are intended to fall within the scope of this invention. Thus, it is understood that other applications of the present invention will be apparent to those skilled in the art upon the reading of the described embodiments and a consideration of the appended claims and drawings.

What is claimed is:

1. A method for distributing a promotion comprising the steps of:
selecting one or more subscribers to receive the promotion based on target subscriber information associated with the promotion and subscriber information associated with each subscriber;
obtaining subscriber delivery information for each of the selected subscribers; and
distributing the promotion to each of the selected subscribers based on the subscriber delivery information for the selected subscriber.

2. The method as recited in claim 1 wherein the target subscriber information comprises one or more target preference categories and a target interest level associated with each target preference category.

3. The method as recited in claim 1 wherein the subscriber information comprises one or more preference categories and a subscriber interest level associated with each preference category.

4. The method as recited in claim 1 wherein the target subscriber information comprises target non-sensitive demographic information.

5. The method as recited in claim 1 wherein the subscriber information comprises non-sensitive demographic information about the subscriber.

6. The method as recited in claim 1 wherein the subscriber delivery information comprises a receiving device type and a receiving device address.

7. The method as recited in claim 1 wherein the subscriber delivery information comprises an acceptable time period to receive the promotion.

8. The method as recited in claim 1 wherein the subscriber delivery information comprises a maximum number of promotions to be received within a specified time period.

9. The method as recited in claim 1 further comprising the step of: receiving feedback from the selected subscribers.

10. The method as recited in claim 1 further comprising the steps of
receiving a request to distribute the promotion; and
retrieving the promotion and the target subscriber information.

11. The method as recited in claim 1 wherein the step of selecting one or more subscribers comprising the steps of:
retrieving the subscriber information for the subscriber; and
selecting the subscriber when a comparison of the target subscriber information to the subscriber information for the subscriber satisfies one or more rules.

12. The method as recited in claim 11 further comprising the step of repeating the steps of retrieving the subscriber information and selecting the subscriber until the one or more subscribers are selected.

13. The method as recited in claim 1 wherein the step of obtaining subscriber delivery information further comprises the steps of:
requesting the subscriber delivery information for each selected subscriber using a subscriber identification for each selected subscriber; and
receiving the subscriber delivery information.

14. The method as recited in claim 1 wherein the step of distributing the promotion further comprising the steps of:
creating a message that contains the promotion and is formatted for a receiving device for each selected subscriber; and
sending the message to the receiving device for each selected subscriber if the selected subscriber has not been sent a specified number of messages within a specified time period.

15. A method for distributing a promotion comprising the steps of:
receiving a request to distribute the promotion;
retrieving the promotion and target subscriber information associated with the promotion from a first database;
retrieving subscriber information for one or more subscribers from a second database;
selecting the subscriber when a comparison of target subscriber information to the subscriber information for the subscriber satisfies one or more rules;
requesting subscriber delivery information for each selected subscriber using a subscriber identification for each selected subscriber, wherein the subscriber delivery information is stored on a third database;
receiving the subscriber delivery information;
creating a message that contains the promotion and is formatted for a receiving device for each selected subscriber; and
sending the message to the receiving device for each selected subscriber if the selected subscriber has not been sent a specified number of messages within a specified time period.

16. A computer program embodied on a computer readable medium for distributing a promotion comprising:
a code segment for selecting one or more subscribers to receive the promotion based on target subscriber information associated with the promotion and subscriber information associated with each subscriber;
a code segment for obtaining subscriber delivery information for each of the selected subscribers; and
a code segment for distributing the promotion to each of the selected subscribers based on the subscriber delivery information for the selected subscriber.

17. The computer program as recited in claim 16 wherein the target subscriber information comprises one or more target preference categories and a target interest level associated with each target preference category.

18. The computer program as recited in claim 16 wherein the subscriber information comprises one or more preference categories and a subscriber interest level associated with each preference category.

19. The computer program as recited in claim 16 wherein the target subscriber information comprises target non-sensitive demographic information.

20. The computer program as recited in claim 16 wherein the subscriber information comprises non-sensitive demographic information about the subscriber.

21. The computer program as recited in claim 16 wherein the subscriber delivery information comprises a receiving device type and a receiving device address.

22. The computer program as recited in claim 16 wherein the subscriber delivery information comprises an acceptable time period to receive the promotion.

23. The computer program as recited in claim 16 wherein the subscriber delivery information comprises a maximum number of promotions to be received within a specified time period.

24. The computer program as recited in claim 16 further comprising a code segment for receiving feedback from the selected subscribers.

25. The computer program as recited in claim 16 further comprising:
a code segment for receiving a request to distribute the promotion; and
a code segment for retrieving the promotion and the target subscriber information.

26. The computer program as recited in claim 16 wherein the code segment for selecting one or more subscribers comprising:
a code segment for retrieving the subscriber information for the subscriber; and
a code segment for selecting the subscriber when a comparison of the target subscriber information to the subscriber information for the subscriber satisfies one or more rules.

27. The computer program as recited in claim 16 further comprising a code segment for repeating the retrieval of the subscriber information and selection of the subscriber until the one or more subscribers are selected.

28. The computer program as recited in claim 16 wherein the code segment for obtaining subscriber delivery information further comprises:
a code segment for requesting the subscriber delivery information for each selected subscriber using a subscriber identification for each selected subscriber; and
a code segment for receiving the subscriber delivery information.

29. The computer program as recited in claim 16 wherein the code segment for distributing the promotion further comprising:
a code segment for creating a message that contains the promotion and is formatted for a receiving device for each selected subscriber; and
a code segment for sending the message to the receiving device for each selected subscriber if the selected subscriber has not been sent a specified number of messages within a specified time period.

30. A system for distributing a promotion comprising:
a profile manager;
a subscriber selector communicably connected to the profile manager, the subscriber selector selecting one or more subscribers to receive the promotion based on target subscriber information associated with the promotion and subscriber information associated with each subscriber, and obtaining subscriber delivery information for each of the selected subscribers via the profile manager;
a first database communicably connected to the subscriber selector, the first database storing the target subscriber information;
a second database communicably connected to the subscriber selector, the second database storing the subscriber information;
a third database communicably connected to the profile manager, the third database storing the subscriber delivery information; and
a distributor communicably connected to the subscriber selector, the distributor distributing the promotion to each of the selected subscribers based on the subscriber delivery information for the selected subscriber.

31. The system as recited in claim 30 wherein the target subscriber information comprises one or more target preference categories and a target interest level associated with each target preference category.

32. The system as recited in claim 30 wherein the subscriber information comprises one or more preference categories and a subscriber interest level associated with each preference category.

33. The system as recited in claim 30 wherein the target subscriber information comprises target non-sensitive demographic information.

34. The system as recited in claim 30 wherein the subscriber information comprises non-sensitive demographic information about the subscriber.

35. The system as recited in claim 30 wherein the subscriber delivery information comprises a receiving device type and a receiving device address.

36. The system as recited in claim 30 wherein the subscriber delivery information comprises an acceptable time period to receive the promotion.

37. The system as recited in claim 30 wherein the subscriber delivery information comprises a maximum number of promotions to be received within a specified time period.

38. The system as recited in claim 30 wherein the subscriber selector receive s a request to distribute the promotion and retrieves the promotion and the target subscriber information.

39. The system as recited in claim 30 wherein the subscriber selector retrieves the subscriber information for the subscriber and selects the subscriber when a comparison of the target subscriber information to the subscriber information for the subscriber satisfies one or more rules.

40. The system as recited in claim 30 wherein the subscriber selector requests the subscriber delivery information for each selected subscriber using a subscriber identification for each selected subscriber and receives the subscriber delivery information.

41. The system as recited in claim 30 wherein the subscriber selector creates a message that contains the promotion and is formatted for a receiving device for each selected subscriber, and the distributor sends the message to the receiving device for each selected subscriber if the selected subscriber has not been sent a specified number of messages within a specified time period.
